(19) United States
(12) Patent Application Publication
(10) Pub. No.: US 2026/0227790 A1
(43) Pub. Date: Aug. 6, 2026

(54) AUTONOMOUS VEHICLE WITH ELECTRONIC DEVICE AND METHOD FOR AUTOMATED OBSTACLE MAPPING FOR AUTONOMOUS VEHICLE

(71) Applicant: Autonomous Solutions, Inc., Mendon, UT (US)

(72) Inventors: Taylor Bybee, Mendon, UT (US); Chui Vanfleet, Logan, UT (US)

(73) Assignee: Autonomous Solutions, Inc., Mendon, UT (US)

(21) Appl. No.: 19/309,592

(22) Filed: Aug. 25, 2025

Related U.S. Application Data
(60) Provisional application No. 63/753,940, filed on Feb. 5, 2025.

(51) Int. Cl. G05D 1/622; G05D 1/246

(52) U.S. Cl. CPC G05D 1/622; G05D 1/2462

(57) ABSTRACT

An electronic device for an autonomous vehicle is provided. The electronic device includes a processor and a memory storing instructions that, when executed, cause the processor to acquire sensor data from a sensor array, detect one or more objects based on the sensor data, and generate virtual boundaries for the detected objects. The processor analyzes predefined physical attributes to distinguish between permanent and temporary obstacles, selectively identifies permanent obstacles for inclusion in a digital map and transforms virtual boundaries into geo-referenced coordinates. The geo-referenced coordinates are transmitted to a base station based on predefined triggers for incorporation into the digital map used by the autonomous vehicle for navigation.

### BACKGROUND

Autonomous vehicles are increasingly being deployed in complex outdoor environments such as golf courses, agricultural fields, and landscaped areas, where accurate digital maps are essential for safe and efficient operation. The complex outdoor environments contain numerous obstacles including trees, structures, terrain features, and equipment that must be precisely mapped to enable autonomous navigation. Traditional mapping processes require operators to manually drive the autonomous vehicle around each individual obstacle to create boundary definitions, which are labor-intensive, time-consuming, and prone to human error.

Current mapping methodologies for the autonomous vehicles rely heavily on manual commissioning processes where operators must physically trace the perimeter of every obstacle using GPS waypoints. For example, when commissioning an autonomous mower for golf course operation, operators must manually drive around each tree, bunker, and landscape feature to establish obstacle boundaries in the mapping system. The manual approach of mapping suffers from various limitations, for example, GPS accuracy may not precisely align with actual obstacle edges, seasonal changes such as vegetation growth render maps outdated within months, and the process requires extensive operator time and expertise.

While the autonomous vehicles are equipped with sophisticated perception systems including Light Detection and Ranging (LiDAR), cameras, and radar sensors capable of detecting obstacles during operation, current mapping methods fail to leverage the sensing capabilities during the initial commissioning phase. The existing systems enabled obstacle detection only during autonomous operation when the autonomous vehicle encountered unexpected obstacles, requiring the autonomous vehicle to stop and manual confirmation for map inclusion. The existing systems do not address the fundamental inefficiency of manual commissioning and cannot distinguish between obstacles that warrant permanent map inclusion versus temporary objects that should be filtered out.

### SUMMARY

An autonomous vehicle and an electronic device that controls an autonomous vehicle is disclosed that are capable of automated mapping and avoiding obstacles in an area is disclosed. A map is generated manually first and subsequently updated in real time during the operation of the autonomous vehicle. Further, an electronic device for an autonomous vehicle, the autonomous vehicle, and a method for automated obstacle mapping for the autonomous vehicle, as shown in and/or described in connection with at least one of the figures, as set forth more completely in the claims.

These and other advantages, aspects, and novel features of the present disclosure, as well as details of an illustrated embodiment thereof, will be more fully understood from the following description and drawings.

The various examples described in the summary and this document are provided not to limit or define the disclosure or the scope of the claims.

### BRIEF DESCRIPTION OF THE FIGURES

FIG. 1 illustrates a block diagram of an example autonomous vehicle communication system of the present disclosure.

FIG. 2 is a side view of an autonomous yard truck according to some embodiments.

FIG. 3 is a side view of an autonomous mower according to some embodiments.

FIG. 4 is a side view of an autonomous tractor according to some embodiments.

FIG. 5 is a flowchart of a method for automated obstacle mapping for an autonomous vehicle of the present disclosure.

FIG. 6 is a block diagram of an example computational system (or controller).

### DETAILED DESCRIPTION

Some embodiments of the present disclosure relate to automated obstacle mapping for an autonomous vehicle. For example, in some embodiments, the present disclosure relates to automated map generation using onboard perception systems. A perception system can enable the detection, classification, and geo-referencing of obstacles based on sensor data acquired during both manual and autonomous operation. The obstacle data obtained during both manual and autonomous operation is selectively transmitted to a mapping system for integration into a digital map. The integration of obstacle data into the digital map may reduce reliance on manual boundary marking and enhances the accuracy and efficiency of map creation.

The disclosed embodiments address challenges associated with efficient and accurate environmental perception, classification, and map updating for the navigation of the autonomous vehicle, particularly in complex and dynamic operational environments such as golf courses, mining sites, agricultural fields, landscaping areas, etc. The present invention enables the autonomous vehicle to maintain high-precision situational awareness while reducing the burden of manual mapping processes traditionally required during vehicle commissioning or environmental changes, thereby facilitating semi-automated or fully automated map generation and maintenance.

Conventional approaches to environmental mapping for autonomous vehicles rely on manual data collection and static mapping techniques, where operators manually trace the periphery of objects using global positioning system (GPS) based tools to generate boundary data. These conventional methods are time-consuming, error-prone, and often fail to reflect temporal changes in the environment, such as seasonal vegetation growth where tree canopies may expand significantly between initial mapping periods and/or dynamic object placement including temporary signage, maintenance equipment, or debris. The manual GPS tracing process inherently suffers from spatial inaccuracies where GPS boundaries may not precisely align with actual obstacle edges, creating discrepancies between mapped locations and real-world obstacle positions. Additionally, traditional mapping methods do not distinguish between temporary obstacles (for example, movable signs, personnel, or maintenance equipment) and permanent obstacles (for example, trees, buildings, or fixed structures), leading to digital map clutter and reduced path planning efficiency. Furthermore, systems that previously enabled obstacle detection during operation of the autonomous vehicle lacked the ability to automatically integrate perception data into the digital map, requiring manual user intervention to confirm the inclusion of new objects and operating only during vehicle stoppage rather than continuous operation.

An autonomous vehicle is disclosed that includes an electronic device that receives sensor data from a sensor array coupled to the autonomous vehicle, where the sensor array comprises one or more of three-dimensional LiDAR, two-dimensional LiDAR, cameras, radar sensors, ultrasonic sensors, and other advanced perception devices. The electronic device includes a processor and memory storing instructions for executing a method that detect objects using multi-sensor fusion operation, generate high-precision virtual boundaries by creating polygon outlines around detected objects, classify objects based on predefined physical attributes including height thresholds and geometric characteristics, and selectively transform and transmit geo-referenced coordinate data to a centralized mapping system (e.g., Mobius produced by Autonomous Solutions, Inc.). Unlike conventional systems and methods, the electronic device of the autonomous vehicle of the present disclosure supports real-time or triggered updating of the digital map based on perception data gathered during both manual operation such as during initial commissioning when operators manually drive the autonomous vehicle to define operational boundaries and autonomous operation phases. The dual-mode capability allows the mapping process to be semi-automated or fully automated without requiring user input during commissioning, significantly reducing manual labor and improving mapping accuracy.

The processor of the electronic device is configured to implement an intelligent filtering operation that analyzes detected obstacles based on multiple criteria including size thresholds, three-dimensional shape characteristics, height parameters, persistence over time, and classification confidence levels derived from advanced machine learning techniques including deep learning algorithms. The processor distinguishes between permanent obstacles that exceed predefined height thresholds and temporary obstacles below such thresholds. Further, the size threshold can also include breadth or width threshold, where the processor distinguishes between permanent and temporary obstacles when the obstacles breadth or width exceeds a certain size, like Sand or dirt piles, large debris or fallen trees, tournament infrastructure etc. The selective mapping approach, for example, can reduce map congestion, prevent false obstacle accumulation, and/or improve overall navigational accuracy and path planning efficiency. The electronic device can, for example, implement flexible transmission triggers including distance-based triggers (i.e., transmitting obstacle data every predetermined distance travelled, such as every few meters), time-based triggers for periodic updates, and on-demand requests from the base station, ensuring optimal balance between map concurrency and communication efficiency. By leveraging advanced object detection operations, multi-sensor fusion capabilities, and geo-referencing technologies including both GPS and GPS-denied localization methods, the autonomous vehicle ensures that only relevant, high-confidence, and accurately positioned environmental features are incorporated into the operational map. An autonomous vehicle, equipped with the disclosed electronic device, may benefit from enhanced situational awareness, adaptive navigation capabilities that accommodate environmental changes, and minimized human involvement, providing particular advantages in specialized applications such as autonomous fairway mowers that must navigate around trees, bunkers, and hazards, mining vehicles operating in dynamic excavation environments, agricultural equipment managing crop and terrain obstacles, and landscaping vehicles operating in complex outdoor domains with diverse obstacle types and seasonal variations.

Unlike conventional systems that only detect obstacles during autonomous operation, the disclosed autonomous vehicle with the electronic device enables automatic obstacle detection during manual commissioning phases, semi-automating the traditionally tedious mapping process. The autonomous vehicle equipped with the electronic device integrates with existing mapping platforms (e.g., Mobius) to automatically generate obstacle boundaries without requiring operators to manually trace each obstacle.

In the following description, reference is made to the accompanying drawings, which form a part hereof, and in which are shown, by way of illustration, various embodiments of the present disclosure.

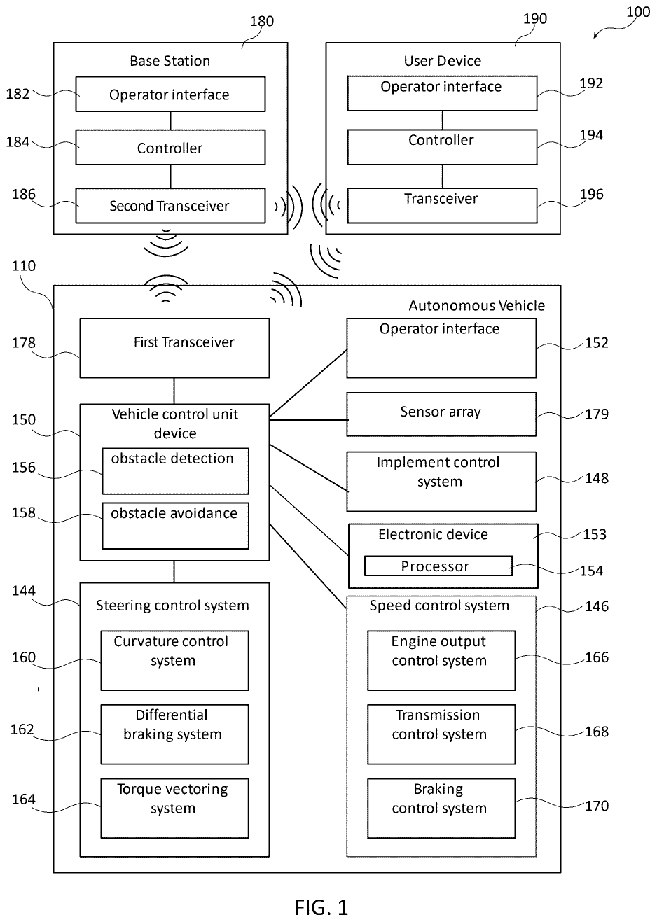

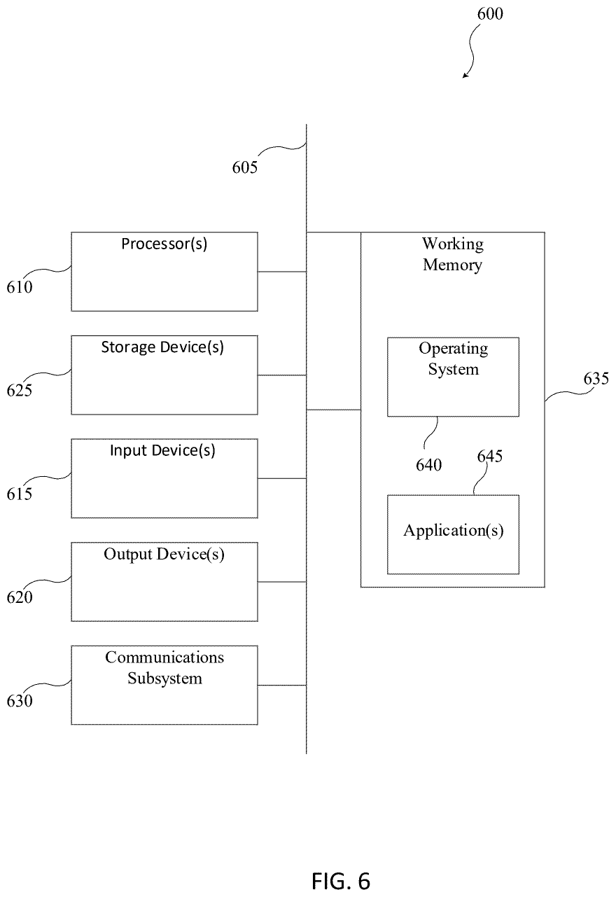

FIG. 1 is a block diagram of a communication and control system 100 that may be utilized in conjunction with the systems and methods of the disclosure. The communication and control system 100 may include a vehicle control unit 150 which may be mounted on an autonomous vehicle 110. The autonomous vehicle 110, for example, may include a yard truck, loader, wheel loader, track loader, dump truck, digger, backhoe, forklift, etc. The communication and control system 100, for example, may include any or all components of computational system 600 shown in FIG. 6. The vehicle control unit 150 may include an obstacle detection 156 and an obstacle avoidance 158 routines.

For example, the autonomous vehicle 110 may include a steering control system 144 that may control the direction of movement of the autonomous vehicle 110. The steering control system 144, for example, may include any or all components of computational system 600 shown in FIG. 6.

The autonomous vehicle 110, for example, may include a speed control system 146 that controls the speed, acceleration, and deceleration of the autonomous vehicle 110. The speed control system 146, for example, may control the speed of the autonomous vehicle 110 based on map data, control algorithms, obstacle detection, start and/or stop points, input from a controller 184 of a base station 180. The speed control system 146, for example, may include any or all components of computational system 600 shown in FIG. 6.

The autonomous vehicle 110, for example, may include an implement control system 148 that may control operation of an implement towed to the autonomous vehicle 110 or integrated within the autonomous vehicle 110 or coupled to the autonomous vehicle 110. The implement control system 148 may, for example, may include any type of implement such as, for example, a bucket, a shovel, a blade, a thumb, a dump bed, a plow, an auger, a trencher, a scraper, a broom, a hammer, a grapple, forks, boom, spears, a cutter, a wrist, a tiller, a rake, etc. The implement control system 148, for example, may include any or all components of computational system 600 shown in FIG. 6.

The autonomous vehicle 110, for example, may include an electronic device 153 coupled to the vehicle control unit 150. The electronic device 153 configured to receive sensor data from the sensor array 179 through the vehicle control unit 150 and to transmit navigation commands based on the digital map to the vehicle control unit 150 for controlling autonomous operation of the autonomous vehicle 110.

The electronic device 153 of the autonomous vehicle 110, may include a non-transitory computer readable medium storing instructions for integration with an autonomous vehicle 110 and adapted to support perception-based mapping and navigation systems. The electronic device 153 is configured to interface with existing mapping platforms (e.g., Mobius) enabling seamless integration into established commissioning workflows without requiring replacement of current mapping infrastructure. The electronic device 153 includes standardized communication protocols that enable direct data exchange with current GPS-based mapping tools and commissioning software.

The electronic device 153 of the autonomous vehicle 110 may further include a processor 154, a memory, and one or more communication interfaces. The processor 154 may be operably coupled to the memory. In some examples, the memory may be configured to store data structures, threshold parameters, obstacle classification logic, and map-related information. The one or more communication interfaces may be configured to enable transmission and reception of data between the electronic device 153 and external systems, for example, the base station 180.

In some embodiments, the electronic device 153 of the autonomous vehicle 110 may be operatively connected to the sensor array 179 comprising one or more environmental sensing components, including but not limited to Light Detection and Ranging (LiDAR) sensors, radar sensors, ultrasonic transducers, and optical cameras. The electronic device 153 may further interface with one or more localization systems, such as global navigation satellite systems (GNSS), real-time kinematic (RTK) modules, or inertial navigation systems (INS), to facilitate geo-referencing of environmental features.

The electronic device 153 is structured to support detection and classification of environmental obstacles based on sensor data and to enable selective inclusion of obstacles in the digital map based on predefined physical attributes. In some examples, the electronic device 153 may include a classification module configured to distinguish between permanent and temporary obstacles based on characteristics such as height, volumetric shape, or other predefined metrics.

In some implementations, for example, in a golf course applications scenario, the processor 154 can apply height-based filtering where objects below a threshold, for e.g. 8 inches (20.32 centimeters) in height are classified as temporary obstacles (for example, signage or movable barriers), while objects exceeding the threshold are classified as permanent obstacles. The processor 154 distinguishes between thin objects like signs versus volumetric objects like trees or bushes with help of three-dimensional shape analysis.

The electronic device 153 of the autonomous vehicle 110 can, for example, provide automated identification of relevant environmental features, reduction in manual mapping effort, improved map accuracy through integration of perception-based boundaries, and enhanced adaptability of autonomous navigation systems to changing environments. The modular architecture of the electronic device 153 further allows for implementation across various autonomous vehicles and operational domains.

During commissioning of an autonomous fairway mower as an example of the autonomous vehicle, the operator can manually drive the autonomous fairway mower along fairway boundaries while the electronic device 153 automatically detects trees, bunkers, and other permanent obstacles, with the help of sensors and other connected measurement devices, without requiring the operator to individually trace each obstacle. The processor 154 filters out temporary objects such as golf cart signs or maintenance equipment while preserving permanent landscape features. This approach of the processor 154 reduces commissioning time from hours to minutes while improving map accuracy compared to manual GPS tracing methods.

The electronic device 153 may, for example, be an integral part of the vehicle control unit 150. Alternatively, the electronic device can be communicably connected with the vehicle control unit via a compatible interface so as to act as an external device integrated with the vehicle control unit 150.

The vehicle control unit 150 of the autonomous vehicle 110 may be communicatively coupled with the steering control system 144, the speed control system 146, and the implement control system 148. The vehicle control unit 150, for example, may include any or all the components shown in FIG. 6. The vehicle control unit 150, for example, may be integrated into a single controller or may include a plurality of distinct components or controllers. The vehicle control unit 150 may also be coupled with one or more sensors from the sensor array 179 and receive sensor data from the sensor array 179.

The vehicle control unit 150, for example, may be used to control various aspects of the vehicle such as, for example, sending instructions to the steering control system 144, implement control system 148, speed control system 146, etc. The vehicle control unit 150, for example, may include a vehicle artificial intelligence (VAI) unit that may include one or more processors that execute one or more algorithms. The VAI unit, for example, can be trained on historical data related to the conditions of the surroundings, like grass length, maintenance records etc. and provide autonomous insights on grass condition monitoring and variable cutting options, adaptive scheduling based on weather and grass conditions, predictive maintenance, fleet coordination etc.

The vehicle control unit 150, for example, may receive signals relative to many parameters of interest including, but not limited to: vehicle position, vehicle speed, vehicle heading, desired path location, off-path normal error, desired off-path normal error, heading error, vehicle state vector information, curvature state vector information, turning radius limits, steering angle, steering angle limits, steering rate limits, curvature, curvature rate, rate of curvature limits, roll, pitch, rotational rates, acceleration, and the like, or any combination thereof. These signals, for example, may come from the sensor array 179 or from the base station 180.

The vehicle control unit 150 of the autonomous vehicle 110, for example, may be an electronic controller with electrical circuitry configured to process data from the various components of the autonomous vehicle 110. The vehicle control unit 150 may include any or all a processor, such as the processor 610, and a working memory 635. The vehicle control unit 150 may also include one or more storage devices and/or other suitable components of computational system 600. The processor 610 may be used to execute software, such as software for calculating drivable path plans. Moreover, the processor 610 may include multiple microprocessors, one or more “general-purpose” microprocessors, one or more special-purpose microprocessors, and/or one or more application specific integrated circuits (ASICS), or any combination thereof. For example, the processor 610 may include one or more reduced instruction set (RISC) processors. The vehicle control unit 150, for example, may include any or all the components shown in FIG. 6.

The vehicle control unit 150, for example, may include a volatile memory, such as random-access memory (RAM), and/or a nonvolatile memory, such as ROM (e.g., working memory 635 and/or storage device 625). The memory may store a variety of information and may be used for various purposes. For example, the memory may store processor-executable instructions (e.g., firmware or software) for the vehicle control unit 150 to execute, such as instructions for calculating driven path plans, and/or controlling the autonomous vehicle 110. The memory may include flash memory, one or more hard drives, or any other suitable optical, magnetic, or solid-state storage medium, or a combination thereof. The memory may store data such as field maps, maps of desired paths, vehicle characteristics, software or firmware instructions and/or any other suitable data.

The steering control system 144, for example, may include a curvature rate control system 160, a differential braking system 162, a steering mechanism, and a torque vectoring system 164 that may be used to steer the autonomous vehicle 110. The curvature rate control system 160, for example, may control a direction of an autonomous vehicle 110 by controlling a steering control system of the autonomous vehicle 110 with a curvature rate, such as an Ackerman style autonomous vehicle, 110 or articulating vehicle. The curvature rate control system 160, for example, may automatically rotate one or more wheels or tracks of the autonomous vehicle 110 via hydraulic or electric actuators to steer the autonomous vehicle 110. By way of example, the curvature rate control system 160 may rotate front wheels/tracks, rear wheels/tracks, and/or intermediate wheels/tracks of the autonomous vehicle 110 or articulate the frame of the vehicle, either individually or in groups. The differential braking system 162 may independently vary the braking force on each lateral side of the autonomous vehicle 110 to direct the autonomous vehicle 110. Similarly, the torque vectoring system 164 may differentially apply torque from the engine to the wheels and/or tracks on each lateral side of the autonomous vehicle 110. While the illustrated steering control system 144 includes the curvature rate control system 160, the differential braking system 162, and the torque vectoring system 164, the steering control system 144 may include one or more of these systems. Further examples may include a steering control system 144 having other and/or additional systems to facilitate turning the autonomous vehicle 110 such as an articulated steering control system, a differential drive system, and the like.

The speed control system 146, for example, may include an engine output control system 166, a transmission control system 168, and a braking control system 170. The engine output control system 166 may vary the output of the engine to control the speed of the autonomous vehicle 110. For example, the engine output control system 166 may vary a throttle setting of the engine, a fuel/air mixture of the engine, a timing of the engine, and/or other suitable engine parameters to control engine output. In addition, the transmission control system 168 may adjust gear selection within a transmission to control the speed of the autonomous vehicle 110. Furthermore, the braking control system 170 may adjust braking force to control the speed of the autonomous vehicle 110. While the illustrated speed control system 146 includes the engine output control system 166, the transmission control system 168, and the braking control system 170, the speed control system 146 may include one or more of these systems. The speed control system 146, for example, may also include other systems and/or additional systems that may be used to control the speed of the autonomous vehicle 110.

The implement control system 148, for example, may control various parameters of the implement towed by and/or integrated within the autonomous vehicle 110. For example, the implement control system 148 may instruct an implement controller via a communication link, such as a CAN bus, ISOBUS, Ethernet, wireless communications, and/or Broad R Reach Type Automotive Ethernet, etc.

The implement control system 148, for example, may instruct an implement controller to adjust a penetration depth of at least one ground engaging tool of an agricultural implement, which may reduce the draft load on the autonomous vehicle 110.

The implement control system 148, as another example, may instruct the implement controller to transition an agricultural implement between a working position and a transport portion, to adjust a flow rate of product from the agricultural implement, to adjust a position of a header of the agricultural implement (e.g., a harvester, etc.), among other operations, etc.

The implement control system 148, as another example, may instruct the implement controller to adjust a shovel height, a shovel angle, a shovel position, etc.

The communication and control system 100, for example, may include a sensor array 179. The sensor array 179, for example, may facilitate determination of condition(s) of the autonomous vehicle 110 and/or the work area. For example, the sensor array 179 may include one or more sensors (e.g., infrared sensors, ultrasonic sensors, magnetic sensors, tachometer, radar sensors, Lidar sensors, terahertz sensors, sonar sensors, wheel encoders, cameras, etc.) that monitor the rotation rate of a respective wheel or track and/or a ground speed of the autonomous vehicle 110. The sensors may also monitor operating levels (e.g., temperature, fuel level, etc.) of the autonomous vehicle 110. Furthermore, the sensors may monitor conditions in and around the work area, such as temperature, weather, wind speed, compass, humidity, and other conditions. The sensors of the sensor array 179, for example, may detect physical objects in the work area, such as a parking stall, a material stall, accessories, other vehicles, obstacles, environmental features, or other object(s) that may be in the area surrounding the autonomous vehicle 110.

The sensor array 179, for example, may include a velocity sensor which may include one or more of an inertial measurement unit, a compass, a GPS sensor, a wheel encoder, a tachometer, a camera, a radar, etc. The sensor array 179, for example, may also include a steering angle sensor. The velocity sensor, for example, may produce velocity data. Velocity data may include speed and/or bearing. Velocity data, for example, may also include steering angular rate. Further, vehicle velocity data comprises acceleration data, inertial measurement unit data, wheel speed data, camera data, velocity data from a wheel encoder, and/or ground speed radar data.

An operator interface 152, for example, may be communicatively coupled to the vehicle control unit 150 and configured to present data from the autonomous vehicle 110 via a display. Display data may include data associated with operation of the autonomous vehicle 110, data associated with operation of an implement, a position of the autonomous vehicle 110, a speed of the autonomous vehicle 110, a desired path, a drivable path plan, a target position, a current position, etc. The operator interface 152 may enable an operator to control certain functions of the autonomous vehicle 110 such as starting and stopping the autonomous vehicle 110, inputting a desired path, etc. The operator interface 152, for example, may enable the operator to input parameters that cause the vehicle control unit 150 to adjust the drivable path plan. For example, the operator may provide an input requesting that the desired path be acquired as quickly as possible, that an off-path normal error be minimized, that the speed of the autonomous vehicle 110 remain within certain limits, that a lateral acceleration experienced by the autonomous vehicle 110 remain within certain limits, etc. In addition, the operator interface 152 (e.g., via the display, or via an audio system (not shown), etc.) may alert an operator if the desired path cannot be achieved.

The vehicle control unit 150 of the autonomous vehicle 110, for example, may be wirelessly communicably connected to a base station 180 having the controller 184 located remotely from the autonomous vehicle 110. For example, the control functions of the vehicle control unit 150 may be distributed between the vehicle control unit 150 and the controller 184. The controller 184, for example, may perform a substantial portion of the control functions of the vehicle control unit 150. For example, a first transceiver 178 positioned on the autonomous vehicle 110 may output signals indicative of vehicle characteristics (e.g., position, speed, heading, curvature rate, curvature rate limits, maximum turning rate, minimum turning radius, steering angle, roll, pitch, rotational rates, acceleration, etc.) to a second transceiver 186 at the base station 180. The controller 184 of the base station 180, for example, may calculate drivable path plans and/or output control signals to control the curvature rate control system 160, the speed control system 146, and/or the implement control system 148 to direct the autonomous vehicle 110 toward the desired path, for example. The controller 184 of the base station 180 may include a processor and memory device having similar features and/or capabilities as the processor and the memory device discussed previously. Likewise, the base station 180 may include an operator interface 182 having a display, which may have similar features and/or capabilities as the operator interface 152 and the display discussed previously.

The base station 180 may incorporate or interface with existing mapping platforms including the mapping systems, allowing the controller 184 to receive geo-referenced obstacle data and seamlessly integrate it into established map databases. The integration preserves existing commissioning workflows while adding automated obstacle detection capabilities.

In some embodiments, whether or both the base station 180 and/or the autonomous vehicle 110 may be in communication with a user device 190 via a transceiver 196 of the user device 190. A user device may include a phone, tablet, laptop, or computer. The user device 190, for example, can include an application that allows the user to communicate commands to the autonomous vehicle 110 and/or receive information about the autonomous vehicle 110. Alternatively, or additionally, the user device 190, for example, can include an application that allows the user to observe the autonomous vehicle 110 move through a map of the work area where the autonomous vehicle operates. Further, the user device 190 may include an operating interface 192 configured to display vehicle status information and provide direct interface access to the mapping system. The operating interface 192 enables operators to review automatically detected obstacles within familiar map displays, approve or reject obstacle inclusions using established mapping system workflows, and monitor integration status between automated detection systems and existing mapping databases.

The user device 190 may also include a controller 194, such as a microcontroller or application-specific integrated circuit (ASIC), configured to process user input, execute application logic, and manage communication between the user interface, the transceiver 196, and the autonomous vehicle 110 or the base station 180.

The user device 190, for example, may include an application that can display any of the GUIs. The user device 190, for example, may include an application that can receive any of the user inputs disclosed in this document. The user device 190, for example, may include an application that can display any of the information disclosed in this document. The user input, for example, may include manual inputs from the user to accept, reject, modify, alter or other such inputs that enable the smooth functioning of the autonomous vehicle for its intended purpose.

In operation, the processor 154 of the electronic device 153 is configured to acquire sensor data from the sensor array 179 coupled to the autonomous vehicle 110. The instructions stored on the non-transitory computer-readable medium enable the processor 154 to initiate data acquisition by interfacing with one or more hardware abstraction layers, driver libraries, or middleware communication protocols specific to each sensor type. In some embodiments, the instructions may include application programming interface (API) calls or hardware-level signal requests to activate sensing modules of the sensor array 179 and retrieve raw or pre-processed data streams. The data acquisition may be implemented via the communication network for example, as CAN bus, Ethernet, or serial protocols, or via wireless communication standards. The processor 154, upon execution of the instructions, continuously polls the sensor array 179 for available data, retrieves the relevant measurement outputs. In some examples, the relevant measurement outputs may include point clouds, images, signal reflections, or distance readings. The processor 154 stores the incoming sensor data into memory for further usage. The configuration of the computer-readable medium to store such instructions allows for real-time collection of environmental information necessary for object detection, boundary generation, and autonomous decision-making. The integration of sensor data acquisition logic within the instruction set enhances modularity, repeatability, and platform-independence, thereby enabling seamless operation across the autonomous vehicle 110.

The processor 154 is further configured to detect one or more objects based on the acquired sensor data. Upon reception of the acquired sensor data, the processor 154, for example, in the case of LiDAR, may analyze three-dimensional point cloud data to identify dense clusters of spatially correlated reflections, which correspond to solid objects. The dense clusters are further evaluated based on shape, size, and surface continuity to isolate individual objects from the background. Similarly, when using radar data, the processor 154 may examine reflected radio frequency signals to detect the presence and relative motion of objects. In the case of camera input, the processor 154 may apply machine vision algorithms, such as edge detection, semantic segmentation, or convolutional neural networks (CNNs), to recognize and delineate objects in the visual field. In some implementations, data from multiple sensors is fused to enhance the robustness and accuracy of detection. The fused dataset allows the processor 154 to confirm the presence, location, and dimensions of the object by correlating different types of sensor inputs.

In some embodiments, the processor 154 detects one or more objects by implementing a sensor fusion framework that combines data from multiple sensors within the sensor array 179 using Extended Kalman Filter (EKF) algorithms, particle filter methods, and Bayesian inference techniques. The fusion process begins with spatial and temporal alignment of sensor data streams, wherein the processor 154 applies coordinate transformation matrices to convert sensor-specific coordinate systems into a unified vehicle-centric reference frame. For LiDAR-based object detection, the processor 154 implements points cloud processing algorithms including voxel grid filtering to reduce computational complexity, statistical outlier removal to eliminate noise artifacts, and ground plane segmentation, for example, using Random Sample Consensus (RANSAC) algorithms. The processor 154 applies clustering algorithms for example, density based spatial clustering of applications with noise (DBSCAN) or Euclidean clustering to group point cloud data into discrete object candidates. Each cluster is analyzed for geometric properties including bounding box dimensions, centroid locations, and surface normal distributions.

Camera-based object detection employs computer vision algorithms implemented through convolutional neural networks (CNNs) trained for object recognition in outdoor environments. The processor 154 utilizes edge detection algorithms for example, canny edge detection, corner detection using Harris corner detector or Features from Accelerated Segment Test (FAST) algorithms, and blob detection for identifying distinct objects within image frames.

The processor 154 is further configured to generate one or more virtual boundaries corresponding to the one or more detected objects. The processor 154 may generate one or more virtual boundaries by implementing computational geometry algorithms that create precise geometric representations of detected objects'spatial extents. The boundary generation process begins with convex hull computation using algorithms, for example, graham scan or quick Hull to determine the minimal enclosing boundary around object point sets. For objects requiring non-convex representations, the processor 154 implements concave hull algorithms including alpha shapes or chi shapes to generate more accurate boundary representations. The processor 154 generates virtual boundaries at multiple resolution levels to accommodate different operational requirements and computational constraints. High-resolution boundaries provide detailed geometric representations suitable for precise navigation planning, while lower-resolution boundaries enable rapid collision detection and path planning computations. The processor 154 implements level-of-detail (LOD) algorithms that automatically select appropriate boundary resolutions based on object proximity, vehicle speed, and available computational resources.

The virtual boundary generation process incorporates dynamic adjustment mechanisms that account for sensor uncertainty, vehicle motion, and environmental factors. The processor 154 applies probabilistic boundary expansion algorithms that add safety margins based on sensor accuracy characteristics, object detection confidence levels, and vehicle velocity vectors. Boundary points are represented with associated uncertainty ellipses that quantify positional accuracy and enable probabilistic collision risk assessment.

The processor 154 may implement temporal tracking algorithms that maintain boundary consistency across multiple detection cycles. Object boundaries may be tracked using Kalman filter-based prediction models that estimate boundary evolution based on object motion characteristics. The tracking mechanism enables boundary refinement through temporal averaging and helps distinguish between static obstacles and objects in motion that should not be incorporated into static maps. Each generated virtual boundary undergoes validation processes that assess geometric consistency, spatial reasonableness, and compatibility with known environmental constraints. The processor 154 may implement boundary quality metrics including perimeter-to-area ratios, geometric complexity measures, and consistency scores that compare current boundaries with historical object representations.

The processor 154 is further configured to analyze predefined physical attributes of the one or more detected objects to distinguish between permanent obstacles and temporary obstacles. In some examples, the analysis process employs machine learning classification algorithms trained on labeled datasets containing examples of permanent and temporary obstacles encountered in typical autonomous vehicle operating environments. In an implementation, the predefined physical attributes comprise a height threshold, wherein obstacles exceeding the height threshold are classified as permanent obstacles, and obstacles below the height threshold are classified as temporary obstacles. The height analysis may incorporate multiple threshold levels including a primary threshold (for example, inches or 20.32 centimeters), secondary thresholds for nuanced classification (for example, 2 feet or 60.96 centimeters) for distinguishing between small permanent features and large temporary objects), and adaptive thresholds that adjust based on operational context such as mowing applications versus general navigation.

The processor 154 determines three-dimensional volumetric properties including total volume, surface area, aspect ratios in multiple dimensions, and geometric complexity measures such as sphericity and elongation indices. Shape analysis algorithms evaluate geometric features including convexity measures, symmetry properties, and characteristic dimensions to distinguish between natural objects (for example, trees or bushes) and artificial objects (for example, signs or equipment). The processor 154 implements principal component analysis (PCA) to determine object orientation and primary dimensional axes. The processor 154 analyzes sensor-derived material properties including surface reflectivity characteristics from LiDAR intensity data, visual texture properties from camera imagery, and radar reflectance signatures to infer material composition. Objects exhibiting characteristics consistent with vegetation are more likely to be classified as permanent obstacles, while objects showing artificial material signatures may be classified as temporary depending on other attribute factors. The classification process incorporates contextual information including object location relative to known map features, proximity to typical obstacle locations (e.g., fairway edges, building perimeters), and seasonal variation patterns. The processor 154 maintains historical databases of object classifications to identify patterns and improve classification accuracy over time through machine learning adaptation. The processor 154 may implement multi-criteria decision-making algorithms that weigh various attribute factors according to predetermined importance hierarchies. Decision matrices combine height thresholds, volumetric properties, shape characteristics, material inferences, and contextual factors using weighted scoring systems that generate confidence-rated classification decisions.

The classification process accounts for seasonal variations in vegetation growth. For example, tree canopies that expand during growing seasons are automatically detected and updated in map representations, eliminating the need for manual map updates to account for seasonal changes. The processor 154 maintains historical records of obstacle classifications to identify growth patterns and improve prediction accuracy for seasonal modifications.”

The processor 154 is further configured selectively identifying the permanent obstacles for inclusion in a digital map used by the autonomous vehicle for navigation based on the analyzed predefined physical attributes. The identification process implements primary classification thresholds that establish minimum requirements for permanent obstacle designation, including minimum height thresholds, minimum volume thresholds to exclude small debris or temporary items, and geometric stability criteria that ensure objects maintain consistent shapes across multiple detection cycles. The processor 154 may implement confidence scoring mechanisms that assign numerical reliability scores to each classification decision based on multiple contributing factors. The scoring algorithm considers sensor data quality metrics, detection consistency across multiple sensor modalities, temporal stability of object characteristics, and agreement between independent classification algorithms. Confidence scores range from 0.0 to 1.0, with configurable minimum thresholds (for example, 0.7 or higher) required for permanent obstacle designation. The identification process implements specific exclusion criteria designed to prevent temporary objects from being incorporated into permanent maps. Objects classified as temporary obstacles include signage with heights below specified thresholds, movable equipment such as golf cart barriers or maintenance cones, seasonal decorations or temporary installations, vehicles or mobile equipment detected in operating areas, and debris or organic matter that does not meet vegetation classification criteria. The processor 154 may employ hierarchical decision tree structures that evaluate objects through sequential classification stages. The first stage applies basic dimensional criteria to eliminate obviously temporary objects, the second stage evaluates geometric and material properties for intermediate classifications, and the third stage applies contextual and historical analysis for final determination. Each decision node in the tree structure implements probabilistic branching that accounts for classification uncertainty.

The selective identification process incorporates machine learning algorithms that continuously improve classification accuracy through supervised learning on operator-validated examples. The processor 154 maintains training datasets of correctly classified objects and implements online learning algorithms that adapt classification parameters based on operational experience and environmental variations.

The processor 154 is configured to transform the one or more virtual boundaries of identified permanent obstacles into geo-referenced coordinates through a comprehensive coordinate transformation framework that converts local vehicle-centric coordinate systems to standardized global geographic reference frames. The transformation process implements rigorous geodetic conversion algorithms that account for Earth curvature, coordinate system datums, and projection parameters to ensure centimeter-level accuracy in geographic positioning. The transformation process utilizes high-precision GPS positioning data obtained through Real-Time Kinematic (RTK) correction services or Post-Processed Kinematic (PPK) methodologies to establish accurate vehicle positioning references. The processor 154 implements GPS error correction algorithms including ionospheric delay compensation, tropospheric correction models, multipath error mitigation through antenna design and signal processing, and satellite geometry optimization through Dilution of Precision (DOP) analysis. The processor 154 applies precise sensor mounting calibration parameters that account for physical offsets between sensor locations and vehicle reference points. Calibration matrices include translation vectors, rotation matrices, and scale factors that compensate for sensor-specific geometric distortions. The calibration process implements in-situ calibration procedures using known reference targets and landmarks to verify and refine transformation parameters. The processor 154 supports multiple geographic coordinate systems including World Geodetic System 1984 (WGS84 ) for global compatibility, local State Plane Coordinate Systems for regional accuracy optimization, Universal Transverse Mercator (UTM) coordinates for scientific applications, and custom local coordinate systems for site-specific operations. The processor 154 implements on-demand coordinate system conversion capabilities that enable seamless integration with diverse mapping and navigation systems. The coordinate transformation process implements comprehensive uncertainty propagation algorithms that track positional errors through each transformation stage. The processor 154 computes error ellipses and confidence regions for transformed coordinates that account for GPS accuracy limitations, sensor calibration uncertainties, geometric transformation errors, and temporal synchronization tolerances. Error analysis results are incorporated into final coordinate representations to enable probabilistic collision detection and path planning.

For operations in GPS-challenged environments, the processor 154 may implement alternative positioning technologies including inertial navigation systems (INS), visual odometry using Structure from Motion (SfM) algorithms, and landmark-based localization using pre-mapped reference features. The processor 154 maintains seamless transitions between GPS-based and GNSS-denied positioning modes through sensor fusion algorithms that combine multiple positioning sources.

The processor 154 is configured to transmit the geo-referenced coordinates to a base station based on a predefined set of triggers for incorporation into the digital map used by the autonomous vehicle 110 for navigation. In an implementation, the predefined set of triggers comprises at least one of: a distance traveled by the autonomous vehicle, a time interval, or a request received from the base station 180. The processor 154 continuously the predefined set of triggers for example, distance-based triggers that activate when the autonomous vehicle 110 has traveled predetermined distances, for example, configurable from 1 meter to 100 meters depending on mapping resolution requirements. Further, the temporal interval triggers that activate at regular time intervals for example, from 1 second to 300 seconds based on operational dynamics. Furthermore, the event-based triggers that activate upon detection of new obstacles or significant changes to existing obstacle boundaries.

The processor 154 implements the transmission process by using structured data packaging protocols specifically formatted for compatibility with existing mapping systems (e.g., Mobius). The data packets utilize standardized formats that enable direct import into current GPS-based mapping tools without requiring format conversion or manual data entry.

The processor 154 may create data packets containing obstacle identification numbers, coordinate arrays defining boundary polygons, confidence scores and uncertainty measures, temporal stamps indicating detection times, and metadata describing obstacle characteristics and classification results. Further, the processor 154 implements adaptive communication protocols that optimize data transmission based on available communication infrastructure. The Quality of Service (QoS) management is maintained by the processor 154 that prioritizes obstacle data transmission while managing bandwidth limitations and latency constraints. Further, automatic failover mechanisms ensure communication continuity through redundant communication pathways. To minimize communication bandwidth requirements, the processor 154 may implement sophisticated data compression algorithms including lossless coordinate compression using delta encoding and run-length encoding, geometric simplification algorithms that reduce boundary complexity while maintaining essential shape characteristics, and temporal differencing that transmits only changes from previously transmitted maps rather than complete datasets. The processor 154 comprehensive error detection and correction mechanisms including cyclic redundancy check (CRC) algorithms for data integrity verification, automatic repeat request (ARQ) protocols for reliable delivery, and store-and-forward capabilities that buffer transmission data during communication outages. The processor 154 maintains transmission logs and acknowledgment tracking to ensure successful data delivery and provides operator notifications for communication failures.

The processor 154 maintains compatibility with mapping system protocols (e.g., Mobius) by formatting obstacle data according to established mapping data standards. Transmitted obstacle boundaries, for example, can be packaged as polygon coordinates with associated metadata that seamlessly integrate into existing map layers. The system supports mapping specific features such as, for example, obstacle categorization codes, confidence ratings, and temporal stamps that align with current commissioning workflows. Upon transmission, the mapping system can automatically incorporate detected obstacles into active maps or present them for operator review and approval, maintaining existing quality control processes while eliminating manual boundary tracing requirements.”

The distance-based triggers activate when the autonomous vehicle has traveled predetermined distances. Time-based triggers activate at regular intervals (for example, 5-30 seconds during commissioning operations). Event-based triggers activate immediately upon detection of obstacles meeting permanent classification criteria.

In an implementation, the geo-referenced coordinates replace the virtual boundary marking of permanent objects in the digital map. By converting virtual boundaries initially defined in the local frame of reference based on raw sensor data into precise geo-referenced coordinates, the processor 154 ensures that each mapped object maintains a fixed and consistent position within the global coordinate framework used by the autonomous vehicle. This eliminates positional drift, improves cross-session map consistency, and enables seamless integration with other geo-spatial datasets. Moreover, storing compact geo-referenced polygons or coordinates reduces the computational burden and memory footprint associated with maintaining full-resolution sensor-derived boundary data. This allows for faster real-time map processing and more efficient transmission to base stations or centralized servers. In dynamic environments where autonomous vehicles operate over extended periods, such geo-referenced mappings also facilitate reliable obstacle re-identification, predictive navigation, and multi-vehicle coordination based on a shared, globally aligned representation of the environment.

Upon successful transmission, the processor 154 receives confirmation signals from the base station 180 indicating successful incorporation of transmitted obstacle data into the updated digital maps. All communication transmissions implement robust security measures including data encryption using Advanced Encryption Standard (AES) algorithms, digital signature verification for data authenticity, and secure authentication protocols that prevent unauthorized access to mapping systems. The processor 154 maintains secure key management systems and implements certificate-based authentication for the communications of base station 180. The order of the various blocks in process can occur in any order. Additionally, or alternatively, one or more blocks may be skipped, one or more blocks may be performed in parallel, and/or one or more blocks may be combined, and/or one or more blocks may be performed in any number of sub-blocks.

The processor 154 is further configured to receive an updated digital map from the base station with instructions to navigate the autonomous vehicle 110 along a path that avoids the geo-referenced coordinates. The processor 154 may maintain a persistent communication channel with the base station 180, to allow real-time or periodic reception of the digital map updates. The base station 180 may transmit map data in the form of structured messages. The structured messages may include updated obstacle information (e.g., geo-referenced coordinates, polygonal boundaries, classification metadata, and navigation directives derived from centralized processing).

The processor 154 may be configured to deserialize and interpret the received map data and to identify changes relative to the local map. The changes may include newly detected permanent obstacles, updated boundary geometries, or restricted areas that must be avoided during path planning. The processor 154 may then integrate the updated digital map into internal navigation framework of the autonomous vehicle 110 by transforming the geo-referenced coordinates into the local coordinate frame based on the current position of the autonomous vehicle 110 and localization data.

Once the updated map is integrated, the processor 154 may invoke a global or local path planning algorithm to compute a collision-free path that avoids the geo-referenced coordinates corresponding to permanent obstacles. For example, if the base station 180 transmits a map update indicating a newly added tree with a boundary represented by a polygon centered at specific GPS coordinates, the processor 154 may calculate a path that maintains a minimum clearance threshold (e.g., 1.5 meters) around the polygon's edges.

The processor 154 may also be configured to optimize the new path based on constraints such as terrain slope, object density, heading continuity, and speed limits. Once the new trajectory is generated, the processor 154 may encode it into a sequence of velocity and steering commands and transmit those commands to the vehicle control unit for execution. The processor 154 may continuously monitor feedback from the vehicle's sensor array and control systems to verify execution fidelity and issue course corrections if needed. This allows the autonomous vehicle 110 to operate safely and efficiently using the most up-to-date environmental data, even in dynamically changing or semi-structured environments such as golf courses or mining yards.

The processor 154 is further configured to receive an updated digital map from the base station with instructions to navigate the autonomous vehicle 110 along a path that avoids the geo-referenced coordinates. The processor 154 may be configured to communicate with the base station via a wireless communication link, such as Wi-Fi, LTE, or another mobile network protocol, either periodically or in response to a predefined event trigger (e.g., end of a mapping cycle, manual request, or detection of new obstacles). Upon establishing communication, the processor 154 may be configured to receive a structured digital map file or map delta update from the base station, the contents of which include one or more geo-referenced coordinates corresponding to previously detected and classified permanent obstacles.

Upon receipt of the updated map, the processor 154 may be configured to parse the data and identify new or modified map objects, such as object polygons, boundaries, or navigation constraints. The processor 154 may be further configured to align the updated map elements with the local coordinate frame of the autonomous vehicle 110 by referencing real-time localization data provided by an RTK-GPS, IMU, or sensor fusion module. Once aligned, the processor 154 may be configured to execute a path planning operation to compute a navigation route that explicitly avoids the regions bounded by the received geo-referenced coordinates.

For example, if the base station 180 transmits a new obstacle polygon that represent tree in the center of a previously traversable fairway, the processor 154 may generate a re-routed path that maintains a safe buffer (e.g., 1.0 to 1.5 meters) around the tree's mapped boundary. The processor 154 may be configured to segment the planned path into discrete control commands, including steering angles and target velocities, and transmit these commands to the vehicle control unit for actuation via the steering control system and speed control system of the autonomous vehicle 110.

The processor 154 may additionally be configured to continuously monitor vehicle position, heading, and proximity to mapped objects to ensure compliance with the navigation path and to apply corrective actions if deviation is detected. The configuration enables the autonomous vehicle 110 to operate safely and efficiently using real-time, map-informed decision-making.

The processor 154 is further configured to instruct the autonomous vehicle 110 to drive along the path. The processor 154 may to generate a planned path using a module (for example, a navigation module) based on the digital map, the current position of the autonomous vehicle 110, and one or more operating constraints including obstacle locations, steering limits, and terrain geometry. The processor 154 may segment the planned path into a sequence of control commands. The control commands may include steering angles, target velocities, and acceleration profiles. The processor 154 may transmit the control commands to the vehicle control unit 150 via the communication interface for execution by the steering control system 144 and the speed control system 146 of the autonomous vehicle 110.

The processor 154 may continuously monitor real-time feedback from the sensor array 179 to determine whether the autonomous vehicle 110 is accurately following the planned path. For example, during mowing operations on a golf fairway, the processor 154 may maintain a lateral deviation of less than 0.1 meters from the reference trajectory by dynamically adjusting steering input in response to terrain variations or obstacle proximity. The processor 154 may perform velocity modulation based on upcoming path curvature and ensure smooth navigation The processor 154 also ensures safety margins near identified permanent obstacles.

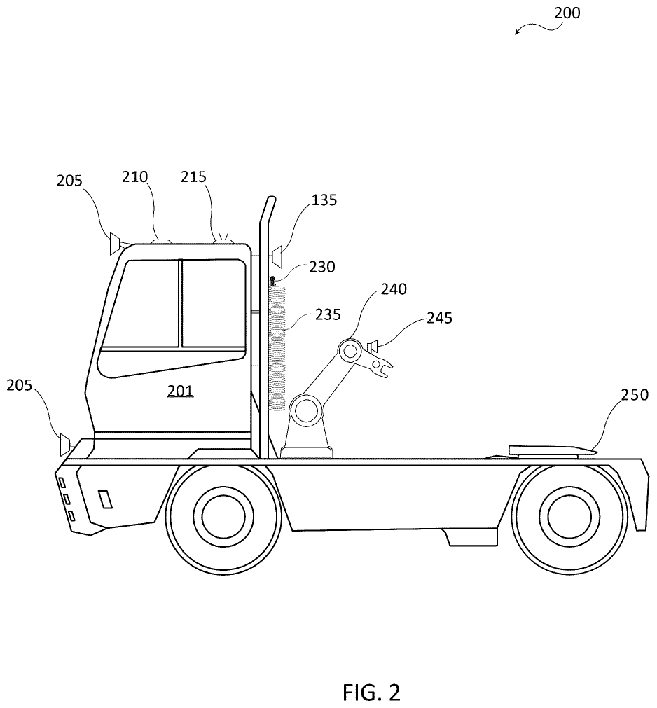

FIG. 2 is a side view of an autonomous yard truck 200 according to some embodiments. The autonomous yard truck 200 includes a cab 201 that may be used to drive the autonomous yard truck 200 manually. The autonomous yard truck 200 may include one or more of the controllers shown in FIG. 1. The autonomous yard truck 200 may also include a brake system, an engine, a transmission, steering, sensor array, etc. such as, for example, as shown in FIG. 1.

In some embodiments, the autonomous yard truck 200 may include a sensor array that includes sensors 205 (e.g., sensor array 179) disposed at various locations on the autonomous yard truck 200 such as, for example, on the cab 201, bumper, housing, frame, etc. The sensors 205 may include infrared sensors, ultrasonic sensors, magnetic sensors, radar sensors, Lidar sensors, terahertz sensors, sonar sensors, cameras, etc. The autonomous yard truck 200 may also include one or more backup sensors 135 such as, for example, infrared sensors, ultrasonic sensors, magnetic sensors, radar sensors, Lidar sensors, Terahertz sensors, sonar sensors, cameras, etc.

In some embodiments, the autonomous yard truck 200 may include a spatial locating device (or GPS) antenna 210. In some embodiments, the autonomous yard truck 200 may include a transceiver antenna 215.

In some embodiments, the autonomous yard truck 200 may include one or more hoses 235 that can be connected with the trailer such as, for example, two or three hoses. Each hose may have a hose connector 230 that can be connected with a trailer hose connector. For example, the autonomous yard truck 200 may include a service brake hose, an emergency brake hose, and/or a refrigerant hose.

In some embodiments, the autonomous yard truck 200 may include a robotic arm 240 disposed on the back bed of the autonomous yard truck 200. The robotic arm 240 may include any type of robotic arm. The robotic arm 240, for example, may exert high torque or high pressure sufficient to connect the hose connector 230 with the trailer hose connector. The hose connector 230 and/or the trailer hose connector may comprise a glad-hand connector. In some embodiments, when the autonomous yard truck 200 is not coupled with a trailer, the hose connector 230 may be positioned in a storage rack at some point on the autonomous yard truck 200 such as, for example, on the rear of the cab 201.

In some embodiments, the robotic arm 240 may include one or more arm sensors 245 such as, for example, infrared sensors, ultrasonic sensors, magnetic sensors, radar sensors, Lidar sensors, terahertz sensors, sonar sensors, cameras, etc. The arm sensor 245, for example, may produce data that can be used to identify the location of a hose connector 230 and/or a trailer hose connector. The arm sensor 245, for example, may produce data that can show that a hose connector 230 and/or a trailer hose connector are sufficiently coupled.

In some embodiments, the autonomous yard truck 200 may include a fifth wheel coupling 250. The fifth wheel coupling 250, for example, may be raised or lowered with a fifth-wheel coupling boom. FIG. 2 shows the fifth wheel coupling 250 in a lowered position. The fifth wheel coupling 250 may couple with a kingpin of a trailer.

When the fifth wheel coupling 250 is coupled with a kingpin and the fifth wheel coupling 250 is in the raised fifth wheel coupling 250 positions, the trailer legs may lift off the ground. This may allow the autonomous yard truck 200 to pull the trailer without individually raising the trailer legs.

In some embodiments, the robotic arm 240 and/or the arm sensor 245 may be coupled with a thermal management system. A thermal management system may, for example, be coupled with a thermal management system associated with the autonomous yard truck 200 such as, for example, coupled with the cab heating/cooling system and/or the engine heating/cooling system. A thermal management system may, for example, be an independent system that heats and/or cools the robotic arm 240 and/or the arm sensor 245. A thermal management system may, for example, keep the temperature of the robotic arm 240 and/or the arm sensor 245 between about 32° F. and about 100° F.

In some embodiments, the autonomous yard truck 200 may include a deployable shade coupled with the back of the cab 201. The deployable shade, for example, may be used to screen the sun and/or other lighting from the arm sensor 245 and/or the one or more backup sensors 135. The deployable shade, for example, may include an umbrella configuration or an awning configuration. The deployable shade, for example, may be coupled with the roof or an upper portion of the cab.

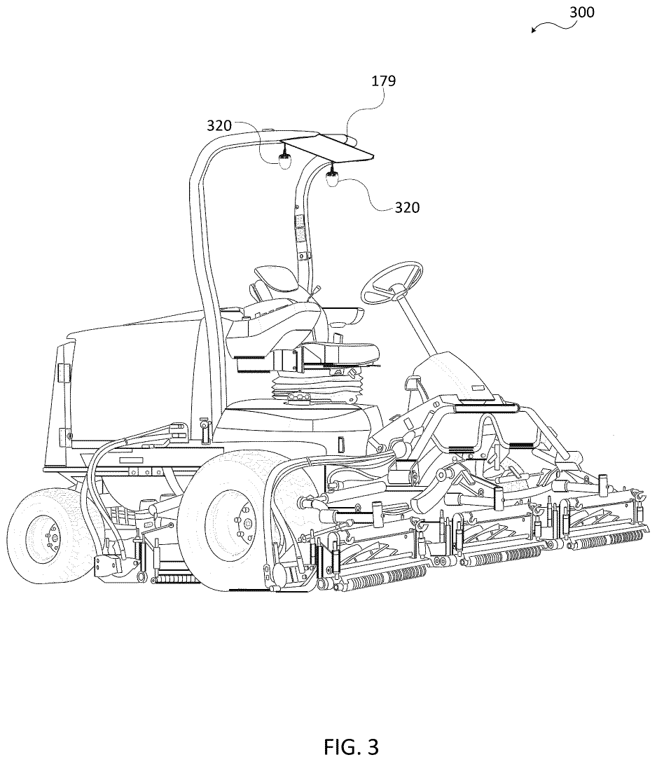

FIG. 3 is a sideview of an example autonomous mower 300, which may include all or some of the components of autonomous vehicle 110. The autonomous vehicle in this document may include the autonomous mower 300. In this example, the autonomous mower 300 includes a disc mower. Any type of mower or blades may be used instead of the disc mower. The autonomous mower 300, for example, includes a sensor array 179 (or multiple sensor arrays). The sensor array 179 may include, for example, one or more lidar, radar, and/or video cameras 320 (as illustrated in embodiment of FIG. 3). The video cameras, for example, may include 360-degree cameras, a front facing camera, and/or a back facing camera.

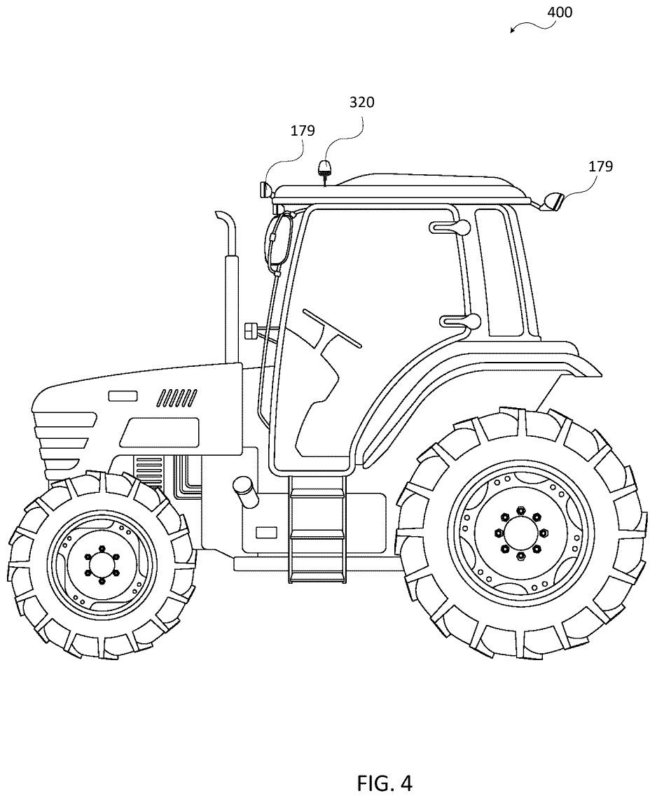

FIG. 4 is a sideview of an example autonomous tractor 400, which may include all or some of the components of autonomous vehicle 110. The autonomous vehicle in this document may include the autonomous tractor 400. In this example, the autonomous tractor 400 may include standard tractor equipment and/or components. The autonomous tractor 400 may include or be coupled with any kind of implement such as, for example, plow, disc plow, reel mower, dumper, lift, bucket, shovel, blade, cutter, etc. The autonomous tractor 400, for example, includes a sensor array 179 (or multiple sensor arrays). The sensor array 179 may include, for example, one or more lidar, radar, and/or video cameras 320 (as illustrated in embodiment of FIG. 4). The video cameras 320, for example, may include 360-degree cameras, a front-facing camera, and/or a back facing camera.

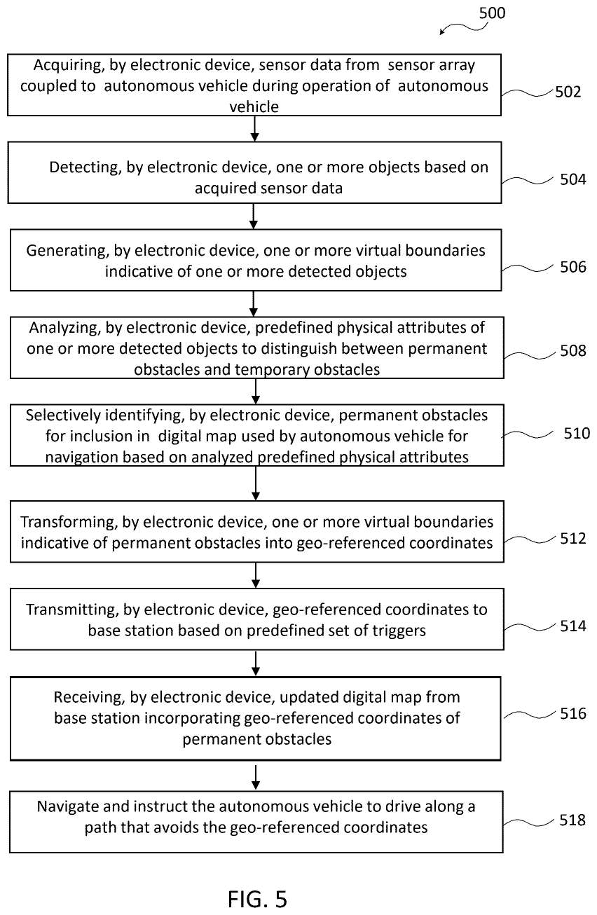

FIG. 5 is a flowchart of a method 500 for automated obstacle mapping for the autonomous vehicle 110 of the present disclosure. The method 500 includes blocks 502 to 518. Any of the blocks in method 500 can be removed, replaced, combined or reordered. Additionally, or alternatively, an additional block(s) may be added at any point during the method 500.

At block 502, acquiring, by the electronic device 153, sensor data from the sensor array 179 coupled to the autonomous vehicle 110 during operation of the autonomous vehicle 110. The electronic device 153, for example, may initiate data acquisition through the communication interface (e.g., CAN bus, Ethernet, or ROS-based middleware) that links to the sensor array 179. The sensor array 179 may include at least one 3D LiDAR sensor configured to emit laser pulses and receive reflected signals to form high-resolution point clouds of surrounding object. Further, the sensor array 179 may include one or more cameras configured to capture RGB or depth imagery for visual perception. In some embodiments, the sensor array 179 may include a radar module configured to detect object range and velocity. Furthermore, the sensor array 179 may include optional ultrasonic sensors configured to measure close-range distances.

The electronic device 153, for example, may be configured to acquire synchronized sensor data streams in real time, using timestamping to align sensor measurements with the current pose of the autonomous vehicle 110. For example, when the autonomous vehicle 110 is manually driven during the mapping process, the LiDAR sensor may sample point clouds at approximately 10-20 hertz (Hz). In some examples, the radar may provide range data at 20 Hz, and cameras may capture frames at 30 FPS. The electronic device 153 may be configured to associate each data frame with time-stamped geolocation coordinates derived from the RTK-GPS and IMU data that allows for accurate spatial alignment of perceived objects in a global map reference frame.

The electronic device 153, for example, may perform preliminary sensor fusion and preprocessing operations. The preprocessing operations may include filtering noise from LiDAR returns, stitching overlapping camera images into a panoramic view, and transforming all sensor data into a unified coordinate system (e.g., East-North-Up or ENU frame). For example, as the autonomous vehicle 110 drives along the boundary of a fairway, the LiDAR sensor may capture reflections from trees, and the electronic device 153 may correlate these returns with GPS-derived position data to construct an annotated point cloud with embedded geospatial metadata. This enables the subsequent detection, classification, and mapping of physical obstacles with improved spatial precision. The improved spatial precision supports the downstream generation of geo-referenced virtual boundaries for map integration.

The electronic device 153, for example, may receive point cloud data from the sensor array (e.g., a LiDAR sensor) in predetermined time packets. The point cloud data, for example, may include data points indicating at least a portion of an operating environment

Unlike autonomous operation where the autonomous vehicle 110 follows predetermined paths, during commissioning an operator may manually drive the autonomous vehicle 110 along area boundaries or obstacles while the sensor array 179 continuously monitors for boundaries and/or obstacles that should be included in the operational map.

At block 504, the method 500 includes detecting by the electronic device 153 one or more objects based on the acquired sensor data. In some embodiments, the sensor array 179 coupled to the autonomous vehicle 110 (e.g., LiDAR sensors) may emit laser pulses and measure the time-of-flight of reflected signals to generate a dense 3D point cloud that represent surface contours and object profiles in the environment. Similarly, cameras may provide RGB images, and radar sensors may capture depth and velocity information, especially in adverse weather or low-visibility conditions.

As the autonomous vehicle 110 traverses a given environment, a localization module—for example, RTK-GPS system, inertial measurement unit (IMU), or GNSS-denied localization system. For example, visual SLAM, can provide position data of the autonomous vehicle 110. The position data may include latitude, longitude, heading, and elevation. The electronic device 153, for example, may fuse the localization data with the raw sensor data using time synchronization techniques (e.g., timestamp alignment or hardware timestamping). Each data frame or packet from the sensor array 179, for example, may thus be mapped to a precise position of the autonomous vehicle 110 at the time of acquisition.

Through sensor fusion and object detection operation executed by the electronic device 153, for example, the autonomous vehicle 110 identifies clusters within the acquired sensor data. The clusters within the acquired sensor data indicate of one or more physical objects. The detected objects are then associated with specific geo-coordinates via transforming their positions from the local coordinate frame of the autonomous vehicle 110 to a global reference frame via use of the current position of the autonomous vehicle 110. The output is a set of detected objects, each annotated with geospatial metadata, enabling accurate virtual boundary generation for subsequent classification and inclusion in a geo-referenced digital map.

The multi-modal object detection approach can provide superior detection accuracy and reliability compared to conventional single-sensor detection systems, for example, by leveraging the complementary strengths of different sensor technologies. The sensor fusion methodology significantly reduces false positive and false negative detection rates through cross-validation of detections across multiple sensor modalities, ensuring that only reliably detected objects proceed to subsequent processing stages. The machine learning-based detection algorithms continuously improve performance through operational experience, adapting to specific environmental conditions and obstacle types encountered in real-world deployments. The real-time detection capability enables immediate response to newly encountered obstacles, providing enhanced safety for autonomous vehicle operations while simultaneously contributing to map accuracy improvements.

At block 506, the method 500 includes generating, by the electronic device 153, one or more virtual boundaries indicative of the one or more detected objects such as, for example, using GPS or other geolocation data. For example, upon detection of an object based on the sensor data, the electronic device 153 may apply clustering or segmentation algorithms (e.g., Euclidean clustering or DBSCAN for LiDAR) to isolate data points corresponding to a single physical object. For example, during operation, if the LiDAR detects a tree on the fairway, the electronic device 153 may identify a dense region of reflected points above a predefined height threshold (e.g., 1 meter), and group those points together as a single obstacle.

Once the object has been isolated, the electronic device 153, for example, may be configured to fit a two-dimensional or three-dimensional boundary around the clustered data points. The boundary may take the form of a convex or concave polygon, a bounding box, or a cylinder, depending on the geometry of the detected object of the sensor data. For example, the electronic device 153 may apply, for example, either a convex hull algorithm to the 2D ground-projected LiDAR points or an alpha shape algorithm to generate a polygonal outline representing the footprint of a tree trunk or utility pole. In another example, for larger objects like boulders or parked equipment, the electronic device 153 may generate a 3D bounding volume enclosing all relevant data points.

The virtual boundary may be defined in the local coordinate frame of the autonomous vehicle 110 and tagged with object metadata such as height, width, shape, classification type, and confidence score. The electronic device 153 may further transform the boundaries into a global map frame via use of data of real-time position of the autonomous vehicle 110 derived from RTK-GPS. The process allows the boundaries to accurately represent the spatial extent of physical obstacles in the environment and serve as intermediate representations for further classification, filtering, or transformation into geo-referenced coordinates for map integration.

The virtual boundary generation may, for example, create geometric models that accurately capture obstacle spatial extents and/or irregular shapes. The one or more virtual boundaries, for example, can have a polygonal shape, which may, for example, enable efficient computational processing for collision detection, path planning, and/or navigation algorithms while maintaining geometric accuracy sufficient for safe autonomous vehicle operation. The virtual boundaries, for example, may provide robust obstacle avoidance capabilities that account for measurement uncertainties and vehicle dynamics. The virtual boundary generation process, for example, may eliminate the need for manual obstacle boundary definition, which may, for example, significantly reduce mapping time and improving boundary accuracy compared to human-generated obstacle representations.

At block 508, the method 500 includes analyzing, by the electronic device 153, predefined physical attributes of the one or more detected objects to distinguish between permanent obstacles and temporary obstacles The electronic device 153, for example, may analyze the predefined physical attributes by first extracting geometric features from segmented object data generated from sensor inputs (e.g., LiDAR point clouds or depth-enhanced imagery). Further, the electronic device 153 may compute attributes that includes object height (from ground plane to topmost point), lateral width and depth (based on horizontal spread in the XY plane), surface area (from convex hull fitting), and volumetric density (based on voxel occupancy or point density in a defined bounding volume).

The electronic device 153, for example, may compare each calculated attribute to predefined classification thresholds. For example, the electronic device 153 may classify a detected object as the permanent obstacle if the object height exceeds 0.5 meters, the footprint area exceeds 0.2 square meters, and the density of LiDAR points exceeds a minimum threshold (e.g., 50 points/m²). Conversely, the electronic device 153 may classify a detected object as a temporary obstacle if the height is less than 0.3 meters, the footprint is narrow (e.g., width<0.2 meters), and the shape matches low profile objects (for example, associated with removable signage or markers).

As another example, the electronic device 153, for example, classify a detected object based on a deep learning algorithm of known images of objects.

To perform the analysis, the electronic device 153, for example, may implement rule-based logic classifiers that operate on real-time sensor data. In some implementations, the electronic device 153 may use principal component analysis (PCA) to evaluate the spread and orientation of point clusters before applying shape filters based on aspect ratio, elongation, or convexity. In some examples, the electronic device 153 may also apply temporal filtering, where consistently detected objects at a fixed global location over multiple operational passes are flagged as permanent, while inconsistent or transient detections are classified as temporary.

At block 510, the method 500 includes selectively identifying, by the electronic device 153, the permanent obstacles for inclusion in a digital map used by the autonomous vehicle 110 for navigation based on the analyzed predefined physical attributes. For example, the electronic device 153 may execute a rule-based classification module that receives input after analysis has been performed by the electronic device 153. The input may include object height, footprint area, point density, and shape descriptors. The electronic device 153 may compare the attributes to predetermined thresholds, such as a height threshold of 0.5 meters and a minimum footprint area of 0.2 square meters (m²) and identify objects that satisfy the criteria as the permanent obstacles.

The electronic device 153, for example, may filter out temporary obstacles such as cones, stakes, or signage by evaluation of the physical characteristics that fall below the threshold values. For example, the electronic device 153 may classify a tree with a cylindrical profile and a consistent LiDAR point density as a permanent obstacle. Further, the electronic device 153 may discard a small field marker with a narrow base and height less than 0.1-meter. The electronic device 153 may also assess temporal consistency by checking if the object is observed at the same geo-referenced location across multiple time intervals.

Objects that meet the classification criteria for permanent obstacles may be assigned unique object IDs and stored in a local map layer or obstacle registry. The electronic device 153 may further tag each identified permanent obstacle with associated metadata. The associated metadata may be boundary shape, dimensions, and geo-coordinates, for downstream transformation into the global reference frame. The selective identification process ensures that only static and persistent features are included in the digital map that reduces mapping errors and improve path planning performance of the autonomous vehicle 110.

The filtering approach, for example, may reduce the risk of misclassification errors by requiring high confidence levels for permanent obstacle designation and/or may ensure that questionable objects undergo additional validation before map inclusion. The selective identification process, for example, may optimizes map storage efficiency by excluding temporary objects that would otherwise contribute to map bloat and increased processing overhead without providing long-term navigation value. The systematic approach to permanent obstacle identification, for example, may enable automated map maintenance that reduces manual map curation requirements while maintaining map accuracy and currency.

At block 512, the method 500 includes transforming, by the electronic device 153, the one or more virtual boundaries indicative of the permanent obstacles into geo-referenced coordinates. For example, the one or more virtual boundaries indicative of the permanent obstacles may be transformed into geo-referenced coordinates using Gnomonic projection, UTM projection, or similar methods. These techniques, for example, may use datums such as WGS84 and/or may utilize an Earth-Centered-Earth-Fixed coordinate system.

The rigorous coordinate transformation methodology, for example, can ensure centimeter-level accuracy in obstacle positioning, which helps in safe navigation of the autonomous vehicle 110 in complex environments with multiple obstacles in proximity. The multi-coordinate system support enables seamless integration with existing mapping infrastructure and geographic information systems, facilitating interoperability between different mapping platforms and enabling collaborative mapping efforts across multiple autonomous vehicles. The geo-referenced coordinates, for example, can provide persistent obstacle references that remain accurate across different operational sessions and/or enable long-term map maintenance and validation processes. The transformation process, for example, can eliminate the need for manual surveying and coordinate measurement of obstacles, significantly reducing mapping time and costs while improving positional accuracy compared to traditional surveying methods.

At block 514, the method 500 includes transmitting, by the electronic device 153, the geo-referenced coordinates to the base station 180 based on a predefined set of triggers. These triggers, for example, may include distance-based triggers (i.e., transmitting geo-referenced coordinates of obstacle data every predetermined distance travelled, such as every few meters), time-based triggers for periodic updates, and/or on-demand requests from the base station 180, ensuring optimal balance between map accuracy and communication efficiency.

The electronic device 153 may transmit the geo-referenced coordinates to the base station 180 by establishing a communication link between the autonomous vehicle 110 and the mapping system that runs on the base station 180. The electronic device 153 may detect the obstacle data including the polygon outlines and transformed coordinates into data packets suitable for transmission to the base station 180. The electronic device 153 may utilize the communication interface to send the geo-referenced coordinates when the predefined set of triggers are satisfied. The distance-based triggers cause transmission every few meters traveled as measured by the odometry of the autonomous vehicle 110. The electronic device 153 may implement time-based triggers by maintaining an internal timer that initiates transmission at predetermined intervals (e.g., every 30 seconds or every minute), to provide periodic updates of detected obstacles to the base station 180. The electronic device 153 may respond to on-demand requests from the base station 180 by monitoring for incoming communication signals. Further, the electronic device 153 may respond to on-demand requests immediately transmitting currently stored geo-referenced coordinates upon receiving such requests from the mapping system of the autonomous vehicle 110. The electronic device 153 may prioritize transmission efficiency by bundling multiple detected obstacles into single transmission packets when multiple obstacles have been detected within the trigger interval. The electronic device 153 may include metadata with each transmission such as timestamp, the vehicle position, and confidence levels of the detected obstacles to enable the base station 180 to properly integrate the received geo-referenced coordinates into the existing map database.

The transmission, for example, can utilize existing communication protocols established for the autonomous vehicle mapping systems, ensuring that obstacle data integrates directly into current commissioning databases. This approach, for example, can preserve operator familiarity with existing interfaces while adding automated obstacle detection capabilities to established workflows. The trigger-based transmission, for example, can optimize communication bandwidth utilization while ensuring that critical obstacle information reaches mapping systems in a timely manner. The trigger criteria, for example, can ensure that map updates occur when most beneficial for navigation accuracy while avoiding unnecessary communication overhead that could impact system performance or incur excessive communication costs. The reliable communication protocols, for example, can include error correction capabilities and may ensure data integrity during transmission, preventing map corruption due to communication errors and maintaining mapping system reliability. The data compression techniques, for example, can reduce bandwidth requirements, and/or enable operation over limited-bandwidth communication channels while maintaining data completeness and accuracy. The multi-channel communication support, for example, can provide redundancy that ensures map updates can be transmitted even when primary communication channels are unavailable, maintaining system functionality across diverse operational environments.

At block 516, the method 500 includes receiving by the electronic device 153, for example, an updated digital map from the base station. This updated digital map, for example, can incorporate the permanent obstacles and/or the geo-referenced coordinates. The updated digital map, for example, may include one or more paths that ensure the autonomous vehicle avoids the permanent obstacles and/or the geo-referenced coordinates.

The electronic device 153 may initiate the reception process by sending acknowledgment signals to the base station 180 to confirm readiness to receive map data. Further, the reception process includes processing of the incoming data streams by the electronic device 153 that contain compressed map files with obstacle polygon data, coordinate arrays, and metadata tags identifying obstacle types and confidence levels.

The electronic device 153 may decode the received updated digital map by parsing data packets that contain serialized map information, where each permanent obstacle is represented as a data structure including vertex coordinates defining polygon boundaries, obstacle classification labels such as “tree” or “structure,” and geo-referenced position data in specific coordinate systems. The electronic device 153 may perform data validation by comparing checksums and digital signatures embedded in the received map data to ensure data integrity during transmission. The data validation further includes deserializing the map data into memory structures accessible by navigation algorithms.

The electronic device 153 may integrate the updated digital map into existing navigation databases via execution of map merge operations. Map merge operations may identify new permanent obstacles, update existing obstacle boundaries based on revised sensor data, and maintain version control to track map evolution over time. The electronic device 153 may process the permanent obstacles by conversion of received polygon coordinate data into internal navigation grid representations. Each cell in the navigation grid is marked as occupied, free, or uncertain based on proximity to permanent obstacle boundaries with configurable safety margins such as 0.5-2 meters depending on vehicle size.

The electronic device 153 may enable autonomous navigation with improved obstacle avoidance through by implementation of path planning operation that reference the updated digital map during route calculation processes. The electronic device 153 may be configured to execute navigation algorithms that treat permanent obstacles as high-cost or impassable nodes in the navigation graph, ensuring generated paths maintain safe clearance from trees, bunkers, and structures with boundaries accurately defined through the perception-assisted mapping process. The electronic device 153 may be configured to provide real-time collision avoidance by continuously monitoring vehicle position relative to permanent obstacle coordinates stored in the updated digital map, triggering immediate path recalculation when the autonomous vehicle 110 approaches within predetermined safety thresholds of permanent obstacles such as 1-3 meters depending on obstacle type and operational parameters of the autonomous vehicle 110.

The updated digital map, for example, may enable autonomous navigation with improved obstacle avoidance capabilities by incorporating accurately geo-referenced permanent obstacles. The updated digital map reception and integration process, for example, may help in from collaborative mapping efforts that incorporate obstacle information detected by multiple vehicles operating in the same or similar environments. The incremental update, for example, may significantly reduce communication bandwidth requirements and update processing time compared to complete map replacement approaches, enabling more frequent map updates that maintain current obstacle information for enhanced navigation safety. The secure communication and validation, for example, may ensure that only verified and authentic map updates are integrated into navigation systems, preventing map corruption or malicious modification that could compromise autonomous vehicle safety. The improved obstacle avoidance capabilities resulting from accurate permanent obstacle incorporation, for example, may enhance navigation efficiency and safety by providing precise obstacle location information that enables optimal path planning and collision avoidance.

The integration with existing mapping platforms such as Mobius provides significant operational advantages by leveraging established commissioning workflows while adding automated capabilities. Operators continue using familiar mapping platform interfaces and quality control processes, while benefiting from reduced manual obstacle tracing requirements. The system maintains compatibility with existing GPS-based tools, allowing mixed-mode operation where operators can supplement automated obstacle detection with manual boundary definition as needed. The backward compatibility ensures smooth technological adoption without disrupting established operational procedures or requiring extensive retraining.

At block 518, the method 500 includes instructing, by the electronic device 153, the autonomous vehicle 110 to drive along a path that avoids the geo-referenced coordinates. For example, the electronic device 153 may execute motion planning algorithm that evaluate the digital map is updated with geo-referenced coordinates indicative of the permanent obstacles. The electronic device 153 may generate a collision-free trajectory based on the current position of the autonomous vehicle 110, destination coordinates, vehicle kinematics, and map geometry. The electronic device 153 may further refine the trajectory in real time via use of local path smoothing algorithms (e.g., Pure Pursuit or Dynamic Window Approach)

The electronic device 153 may translate the planned path into a series of steering and velocity commands based on the curvature and speed limits of the calculated trajectory. The commands may be transmitted over a vehicle bus to the steering control system 144 and the speed control system 146 of the autonomous vehicle 110. The electronic device 153 may further monitor wheel odometry, and real-time sensor feedback to validate path execution and apply corrective adjustments. In some embodiments, when the autonomous vehicle 110 approaches a region containing geo-referenced coordinates representing a detected tree, the electronic device 153 re-routes the path with an offset margin (e.g., 1.5 meters) around the object polygon to maintain safe clearance. The process enables autonomous vehicle 110 to continue navigation without requirement of intervention of the operator, while avoiding previously identified permanent obstacles stored in the updated map.

The blocks 502 to 518 are only illustrative, and other alternatives can also be provided where one or more blocks are added, one or more blocks are removed, or one or more blocks are provided in a different sequence without departing from the scope of the claims herein.

The computational system 600, shown in FIG. 6, can be used to perform any of the examples disclosed in this document. For example, computational system 600 can be used to execute the method 500. As another example, computational system 600 can perform any calculation, identification and/or determination described here. Computational system 600 includes hardware elements that can be electrically coupled via a bus 605 (or may otherwise be in communication, as appropriate). The hardware elements can include one or more processors 610, including without limitation one or more general-purpose processors and/or one or more special-purpose processors (such as digital signal processing chips, graphics acceleration chips, and/or the like); one or more input devices 615, which can include without limitation a mouse, a keyboard and/or the like; and one or more output devices 620, which can include without limitation a display device, a printer and/or the like.

The computational system 600 may further include (and/or be in communication with) one or more storage devices 625, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computational system 600 might also include a communications subsystem X30, which can include without limitation a modem, a network card (wireless or wired), an infrared communication device, a wireless communication device and/or chipset (such as a Bluetooth device, an 802.6 device, a Wi-Fi device, a WiMax device, cellular communication facilities, etc.), and/or the like. The communications subsystem 630 may permit data to be exchanged with a network (such as the network described below, to name one example), and/or any other devices described in this document. The computational system 600, for example, may include a working memory 635, which can include an RAM or ROM device, as described above.

The computational system 600 also can include software elements, shown as being currently located within the working memory 635, including an operating system 640 and/or other code, such as one or more application programs 645, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 625 described above.

The storage medium, for example, might be incorporated within the computational system 600 or in communication with the computational system 600. The storage medium might be separate from a computational system 600 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 600 and/or might take the form of source and/or installable code, which, upon compilation and/or installation on the computational system 600 (e.g., using any of a variety of generally available compilers, installation programs, compression/decompression utilities, etc.) then takes the form of executable code.

The term “autonomous vehicle” includes manned vehicles, remote control vehicles, manual vehicles, etc.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The conjunction “or” is inclusive.

The terms “first”, “second”, “third”, etc. are used to distinguish respective elements and are not used to denote a particular order of those elements unless otherwise specified or order is explicitly described or required.

Numerous specific details are set forth to provide a thorough understanding of the claimed subject matter. However, those skilled in the art will understand that the claimed subject matter may be practiced without these specific details. In other instances, methods, apparatuses, or systems that would be known by one of ordinary skills have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The systems discussed are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more examples disclosed in this document. Any suitable programming, scripting, or other types of language or combinations of languages may be used to implement the teachings contained in software to be used in programming or configuring a computing device.

Embodiments of the methods disclosed may be performed in the operation of such computing devices. The order of the blocks presented in the examples above can be varied; for example, blocks can be re-ordered, combined, and/or broken into sub-blocks. Certain blocks or processes can be performed in parallel.

The use of “adapted to” or “configured to” is meant as open and inclusive language that does not foreclose devices adapted to or configured to perform additional tasks or blocks. Additionally, the use of “based on” is meant to be open and inclusive, in that a process, block, calculation, or other action “based on” one or more recited conditions or values may, in practice, be based on additional conditions or values beyond those recited. Headings, lists, and numbering included are for ease of explanation only and are not meant to be limiting.

While the present subject matter has been described in detail with respect to specific examples, those skilled in art, upon attaining an understanding of these examples, may readily produce alterations to, variations of, and equivalents to such examples. Accordingly, the present disclosure has been presented for purposes of example rather than limitation, and does not preclude inclusion of such modifications, variations and/or additions to the present subject matter as would be readily apparent to one ordinary skill in the art.

That which is claimed:

1. An electronic device for controlling an autonomous vehicle, comprising:
a processor; and
a memory storing instructions that, when executed by the processor, cause the processor to:
acquire sensor data from a sensor array coupled to the autonomous vehicle;
detect one or more objects based on the acquired sensor data;
generate one or more virtual boundaries corresponding to the one or more detected objects;
selectively identify the permanent obstacles for inclusion in a digital map used by the autonomous vehicle for navigation based on the analyzed predefined physical attributes;
transform the one or more virtual boundaries of the identified permanent obstacles into geo-referenced coordinates;
transmit the geo-referenced coordinates to a base station based on a predefined set of triggers for incorporation into the digital map used by the autonomous vehicle for navigation; and
receive an updated digital map from the base station with instructions to navigate the autonomous vehicle along a path that avoids the geo-referenced coordinates.

2. The electronic device of claim 1, wherein the predefined physical attributes comprise a height threshold, wherein obstacles exceeding the height threshold are classified as permanent obstacles, and obstacles below the height threshold are classified as temporary obstacles.

3. The electronic device of claim 1, wherein the predefined set of triggers comprises at least one of: a distance traveled by the autonomous vehicle, a time interval, or a request received from the base station.

4. The electronic device of claim 1, wherein the geo-referenced coordinates replace the virtual boundary marking of permanent objects in the digital map.

5. The electronic device of claim 1, wherein the updated digital map is based on geo-referenced coordinates from one or more vehicles operating in the same environment.

6. The electronic device of claim 1, wherein the updated digital map is received after successful verification and authentication of the geo-referenced coordinates.

7. The electronic device of claim 1, wherein the memory further storing instructions that, when executed by the processor, cause the processor to analyze predefined physical attributes of the one or more detected objects to distinguish between permanent obstacles and temporary obstacles.

8. The electronic device of claim 1, wherein the memory further storing instructions that, when executed by the processor, cause the processor to instruct the autonomous vehicle to drive along the path

9. An autonomous vehicle, comprising:
a sensor array comprising at least one sensor configured to detect one or more objects in an environment;
a steering control system;
a speed control system;
a vehicle control unit communicatively coupled with the sensor array;
an electronic device coupled to the vehicle control unit, the electronic device configured to:
receive sensor data from the sensor array through the vehicle control unit;
transmit navigation commands based on a digital map to the vehicle control unit for controlling autonomous operation of the autonomous vehicle, the electronic device comprising:
a processor; and
a memory storing instructions that, when executed by the processor, cause the electronic device to:
detect one or more objects during operation of the autonomous vehicle using the received sensor data;
generate one or more virtual boundaries corresponding to the one or more detected objects;
analyze predefined physical attributes of the one or more detected objects to distinguish between permanent obstacles and temporary obstacles;
selectively identify the permanent obstacles for inclusion in a digital map used by the autonomous vehicle for navigation based on the analyzed predefined physical attributes; and
transform the one or more virtual boundaries indicative of the identified permanent obstacles into geo-referenced coordinates.

10. The autonomous vehicle of claim 9, wherein the electronic device is further configured to update the digital map with the geo-referenced coordinates of permanent obstacles.

11. The autonomous vehicle of claim 9, wherein the digital map is updated based on geo-referenced coordinates of permanent obstacle from one or more vehicles operating in the same environment.

12. The autonomous vehicle of claim 9, wherein digital map is updated with geo-referenced coordinates of permanent obstacles after successful verification and authentication of the geo-referenced coordinates.

13. The autonomous vehicle of claim 9, wherein the predefined physical attributes comprise a height threshold, wherein obstacles exceeding the height threshold are classified as permanent obstacles, and obstacles below the height threshold are classified as temporary obstacles.

14. The autonomous vehicle of claim 9, wherein the electronic device is further configured to transmit the geo-referenced coordinates to a base station based on a predefined set of triggers for incorporation into the digital map used by the autonomous vehicle for navigation.

15. The autonomous vehicle of claim 14, wherein the predefined set of triggers comprises at least one of: a distance traveled by the autonomous vehicle, a time interval, or a request received from the base station

16. The autonomous vehicle of claim 9, wherein selectively identifying the permanent obstacles comprises using supervised machine learning algorithms.

17. The autonomous vehicle of claim 9, wherein the memory stores instructions that, when executed by the processor, cause the electronic device to instruct the steering control system and the speed control system to drive the autonomous vehicle along a path that avoids the geo-referenced coordinates.

18. A method for automated obstacle mapping for an autonomous vehicle, comprising:
acquiring sensor data from a sensor array coupled to an autonomous vehicle during operation of the autonomous vehicle;
detecting one or more objects based on the acquired sensor data;
generating one or more virtual boundaries indicative of the one or more detected objects;
analyzing predefined physical attributes of the one or more detected objects to distinguish between permanent obstacles and temporary obstacles;
selectively identifying the permanent obstacles for inclusion in a digital map used by the autonomous vehicle for navigation based on the analyzed predefined physical attributes;
transforming the one or more virtual boundaries indicative of the permanent obstacles into geo-referenced coordinates;
transmitting the geo-referenced coordinates to a base station based on a predefined set of triggers; and
receiving an updated digital map from the base station incorporating the permanent obstacles, wherein the updated digital map enables autonomous navigation with improved obstacle avoidance capabilities by incorporating accurately geo-referenced permanent obstacles.

19. The method of claim 18, wherein the predefined physical attributes comprise a height threshold, wherein obstacles exceeding the height threshold are classified as permanent obstacles, and obstacles below the height threshold are classified as temporary obstacles.

20. The method of claim 18, wherein the predefined set of triggers comprises at least one of: a distance traveled by the autonomous vehicle, a time interval, or a request received from the base station.

21. The method of claim 18, wherein the geo-referenced coordinates replace the virtual boundary marking of permanent objects in the digital map.

22. The method of claim 18, wherein the updated digital map is based on geo-referenced coordinates from one or more vehicles operating in the same environment.

23. The method of claim 18, wherein the updated digital map is received after successful verification and authentication of the geo-referenced coordinates.
